(19) United States
(12) Patent Application Publication
(10) Pub. No.: US 2016/0105835 A1
(43) Pub. Date: Apr. 14, 2016

(54) MULTI-MODE POWER SAVING

(71) Applicant: QUALCOMM Incorporated, San Diego, CA (US)

(72) Inventors: Tom CHIN, San Diego, CA (US); Roy Howard DAVIS, Del Mar, CA (US); Ming YANG, San Diego, CA (US)

(21) Appl. No.: 14/511,795

(22) Filed: Oct. 10, 2014

(51) Int. Cl. H04W 36/32; H04W 36/04; H04W 84/12

(52) U.S. Cl. CPC H04W 36/32; H04W 84/12; H04W 36/04

(57) ABSTRACT

A user equipment (UE) avoids entering a limited service state when the UE enters a weak coverage area where a communication service outage occurs with respect to a first radio access technology (RAT) and a second RAT. In one instance, the UE remains on the first RAT during the communication service outage, based on a location of the UE by preventing switching from the first RAT to a second RAT.

### BACKGROUND

1. Field

Aspects of the present disclosure relate generally to wireless communication systems, and more particularly, to avoiding or maintaining a limited service state when a user equipment (UE) enters a weak coverage area where communication on a first radio access technology (RAT) and a second RAT is unavailable.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes remaining on a first radio access technology (RAT) during a service outage, based on a location of a user equipment (UE), by preventing switching from the first RAT to a second RAT.

According to another aspect of the present disclosure, a method for wireless communication includes attempting to access a second radio access technology (RAT) when a first RAT is in a service outage. The method also includes preventing the attempting to access a third RAT when the attempting to access the second RAT fails.

According to still another aspect of the present disclosure, an apparatus for wireless communication includes means for communicating on a first radio access technology (RAT). The apparatus may also include means for remaining on the first RAT during a service outage, based on a location of a user equipment (UE), by preventing switching from the first RAT to a second RAT.

According to yet another aspect of the present disclosure, an apparatus for wireless communication includes means for attempting to access a second radio access technology (RAT) when a first RAT is in a service outage. The apparatus may also include means for preventing the attempting to access a third RAT when the attempting to access the second RAT fails.

Another aspect discloses an apparatus for wireless communication and includes a memory and at least one processor coupled to the memory. The processor(s) is configured to remain on a first radio access technology (RAT) during a service outage, based on a location of a user equipment (UE) by preventing switching from the first RAT to a second RAT.

Still another aspect discloses an apparatus for wireless communication and includes a memory and at least one processor coupled to the memory. The processor(s) is configured to attempt to access a second radio access technology (RAT) when a first RAT is in a service outage. The processor(s) is also configured to prevent the attempting to access a third RAT when the attempting to access the second RAT fails.

Yet another aspect discloses a computer program product for wireless communications in a wireless network having a non-transitory computer-readable medium. The computer readable medium has non-transitory program code recorded thereon which, when executed by the processor(s), causes the processor(s) to remain on a first radio access technology (RAT) during a service outage, based on a location of a user equipment (UE) by preventing switching from the first RAT to a second RAT.

Another aspect discloses a computer program product for wireless communications in a wireless network having a non-transitory computer-readable medium. The computer readable medium has non-transitory program code recorded thereon which, when executed by the processor(s), causes the processor(s) to attempt to access a second radio access technology (RAT) when a first RAT is in a service outage. The program code also causes the processor(s) to prevent the attempting to access a third RAT when the attempting to access the second RAT fails.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 illustrates a multi-mode user equipment configured to support wireless wide area network and wireless local area network communications.

FIG. 6 shows a wireless communication method according to one aspect of the present disclosure.

FIG. 7 is a diagram illustrating an example of a hardware implementation for an apparatus employing a processing system according to aspects of the present disclosure.

FIG. 8 shows a wireless communication method according to one aspect of the present disclosure.

FIG. 9 is a diagram illustrating an example of a hardware implementation for an apparatus employing a processing system according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

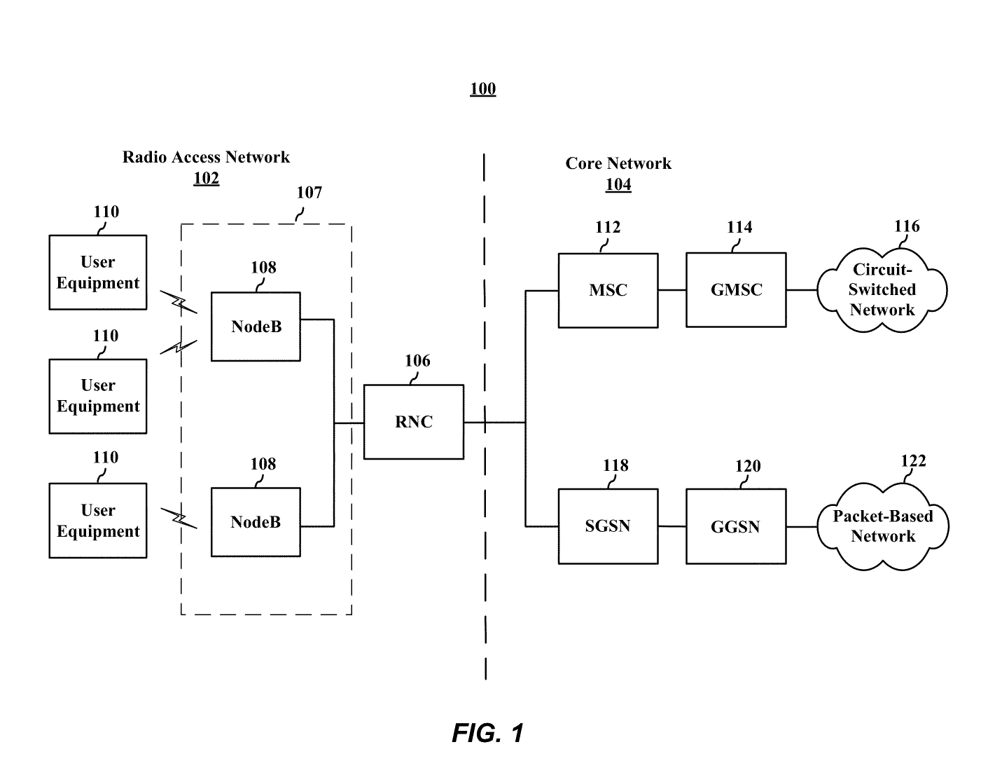

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

General packet radio service (GPRS) is designed to provide packet-data services at speeds higher than those available with standard GSM circuit switched data services. The core network 104 also supports packet-data services with a serving GPRS support node (SGSN) 118 and a gateway GPRS support node (GGSN) 120. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

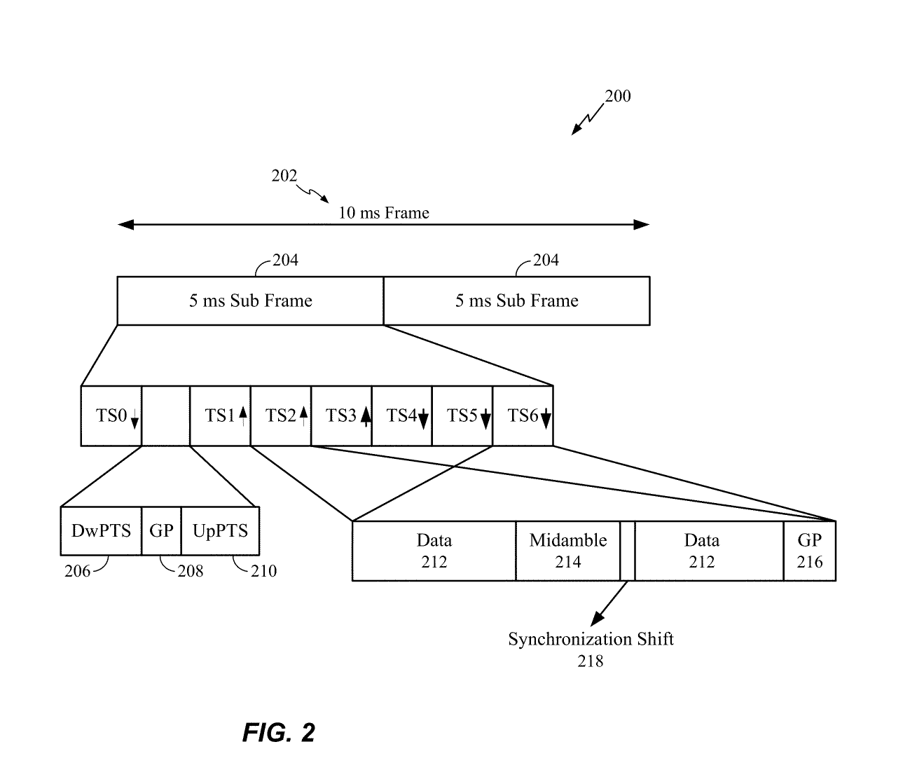

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization Shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

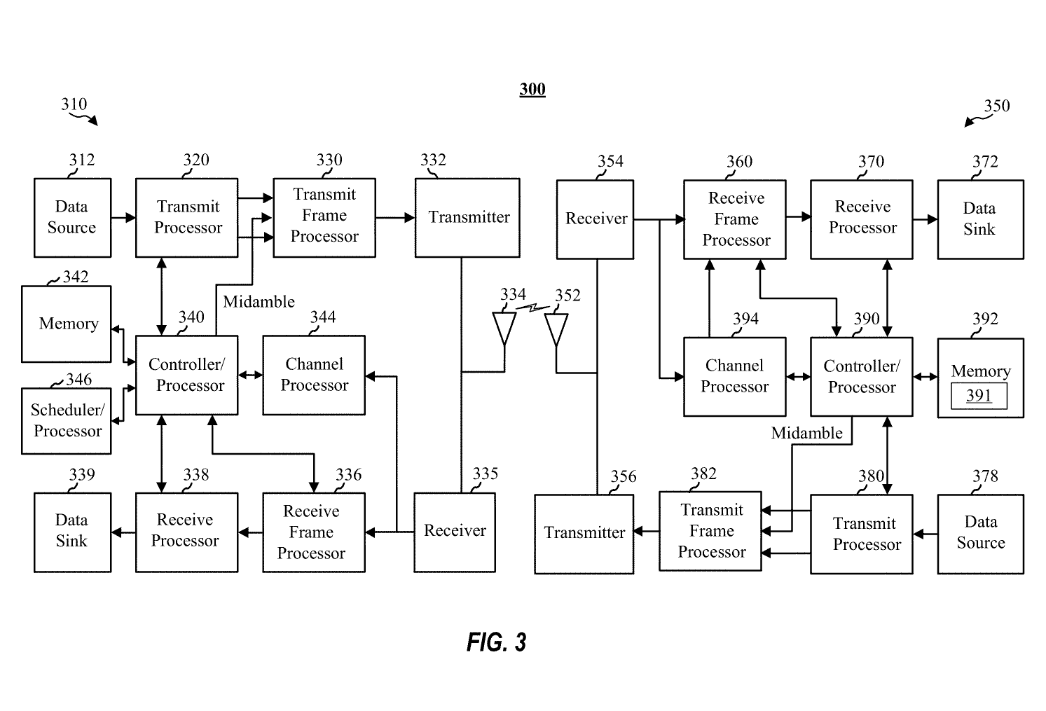

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store a multi-mode power saving module 391 which, when executed by the controller/processor 390, configures the UE 350 to avoid entering a limited service state according to aspects of the present disclosure. A scheduler/processor 346 at the node B 310 may be used to allocate resources to the UEs and schedule downlink and/or uplink transmissions for the UEs.

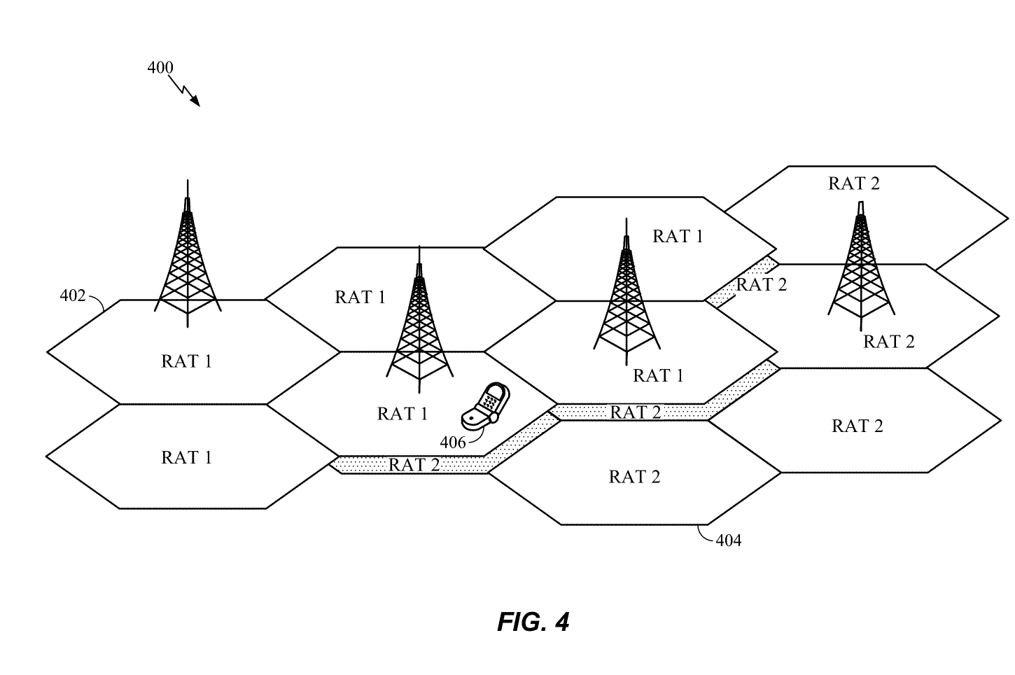

Some networks, such as a newly deployed network, may cover only a portion of a geographical area. Another network, such as an older more established network, may better cover the area, including remaining portions of the geographical area. FIG. 4 illustrates coverage of an established network utilizing a first type of radio access technology (RAT-1), such as GSM, TD-SCDMA or Long Term Evolution (LTE) and also illustrates a newly deployed network utilizing a second type of radio access technology (RAT-2), such as a GSM, TD-SCDMA or Long Term Evolution (LTE). Those skilled in the art will appreciate that the network may contain more than two types of RATs. For example, the geographical area 400 may also include a third RAT, such as, but not limited to GSM, TD-SCDMA or Long Term Evolution (LTE).

The geographical area 400 may include RAT-1 cells 402 and RAT-2 cells 404. In one example, the RAT-1 cells are TD-SCDMA/GSM cells and the RAT-2 cells are LTE cells. However, those skilled in the art will appreciate that other types of radio access technologies may be utilized within the cells. A user equipment (UE) 406 may move from one cell, such as a RAT-1 cell 404, to another cell, such as a RAT-2 cell 402. The movement of the UE 406 may specify a handover or a cell reselection.

In order to expand the services available to subscribers, some user equipments (UEs) support communications with multiple radio access technologies (RATs) for both wireless wide area network (WWAN) such as second/third/fourth (2G/3G/4G) generation cellular technology and wireless local area network (WLAN) communications such as WiFi.

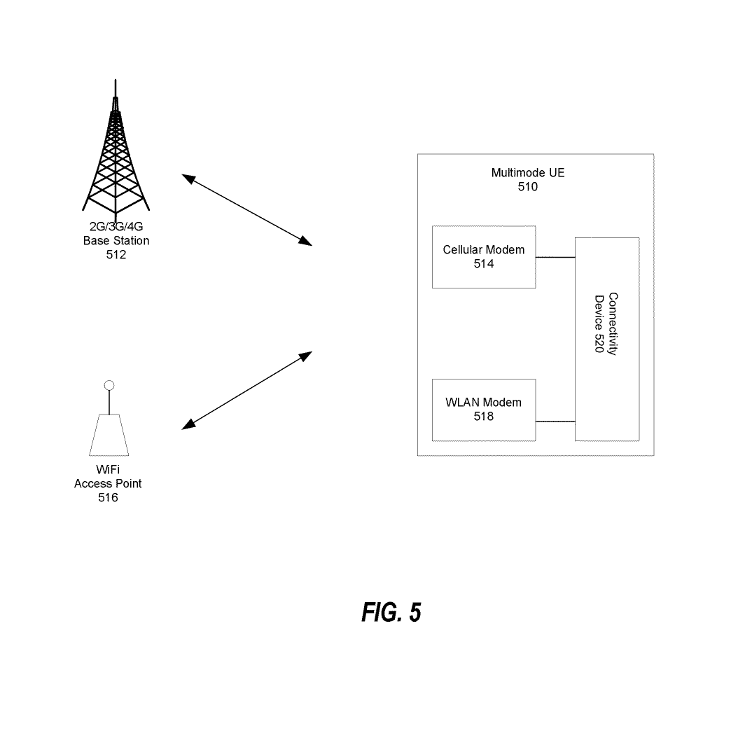

FIG. 5 illustrates a multi-mode user equipment (UE) 510 configured to support wireless wide area network and wireless local area network. For example, as illustrated in FIG. 5, the multi-mode UE 510 may support long-range WWAN services including LTE for broadband cellular/data services, code division multiple access (CDMA) for cellular/voice services, GSM and TD-SCDMA for direct access to communication networks. The multi-mode UE 510 may also support short-range communications, such as WLAN (including WiFi), WiMAX, Bluetooth, and the like, for direct access to the communication networks. The wireless local area network may be provided to offload data traffic from the wireless wide area network or the cellular network.

Illustratively, WWAN communication is supported by a base station 512 and the cellular modem 514 and WLAN communication is supported by the access point 516 and the WLAN modem 518. A connectivity device 520 may be used to exchange information between the cellular modem 514 and the WLAN modem 518. The connectivity device 520 enables a network provider or the user equipment to control how an end user of the multi-mode UE 510 actually connects to the networks.

For example, a network provider may be able to direct the multi-mode UE to connect to the network via the short-range WLAN, when available. This capability may allow a network provider to route traffic in a manner that eases congestion of particular air resources. The traffic may be re-routed from the short-range WLAN when conditions mandate, such as when a mobile user increases speed to a certain level not suitable for short-range WLAN services or when the UE leaves coverage of the WLAN. Moreover, utilizing short-range WLAN services when available may result in less power consumption by the multi-mode UE 510 and, consequently, longer battery life.

In some UEs, switching from a first RAT (e.g., WiFi) to a second RAT (e.g., LTE/GSM/TD-SCDMA) does not include an LTE attach procedure to communicate with the second RAT. For example, the UE may be configured to always attach to or be associated with both the first RAT and the second RAT. Thus, when a communication or communication path (internet protocol data path) of the first RAT fails, the communication path is set to the second RAT. Similarly, when the first RAT is recovered, the communication path is set to the first RAT. For example, the UE may periodically scan the first RAT to determine when the first RAT can be recovered.

When the UE enters a weak coverage area (e.g., an elevator) where communication with both a first RAT and a second RAT is not supported or the communication is unacceptably degraded, the attempts to communicate with either RAT may result in failure (e.g., radio access channel (RACH) failure). For example, the first RAT and the second RAT may become inaccessible for communication at substantially the same time. As a result, ongoing communication (e.g., packet switched communication) may be handed over from one RAT to the other in an attempt to set up a successful communication path. For example, the packet switched communication may be handed over from WiFi to LTE or TD-SCDMA.

In one instance, the UE may be configured to connect to WiFi automatically whenever the phone is in the weak coverage area (e.g., the elevator). When communication on WiFi is not possible (e.g., in the elevator), the UE may automatically switch to LTE or vice versa. As noted, however, LTE communication in the elevator may also be unavailable. As a result, the UE may repeatedly switch between LTE and WiFi when the failure to establish communication with LTE and WiFi continues. Consequently, the UE may enter a limited service state for a period of time when the failure (e.g., random access channel failure) persists.

In the limited service state, the UE experiences a service outage with respect to the first and second RATs. For example, in the limited service state, circuit switched (e.g., mobile terminated, mobile oriented) communication and/or packet switched (e.g., data) communication are subject to the service outage, resulting in communication failure.

In some instances, the UE may switch to a third RAT (e.g. TD-SCDMA/GSM) from the second RAT (e.g., LTE). The UE may switch to the third RAT after a maximum number of unsuccessful attempts to switch to the second RAT. For example, to switch to the third RAT (e.g., GSM), the UE may trigger a routing area update in GSM. A routing area update procedure allows the UE to inform the cellular network, whenever it moves from one routing area to the next. Random access channel (RACH) failure occurs because the GSM coverage is also unacceptable in the weak coverage area.

Continuously switching between the two or more RATs while in the poor coverage area increases power consumption by the multi-mode UE and, consequently, reduces battery life.

### Multi-Mode Power Saving

Aspects of the present disclosure are directed to reducing power consumption and to increasing battery life of a multi-mode user equipment (UE). In one aspect of the disclosure, the UE is prevented from entering a limited service state where the UE repeatedly switches between a first radio access technology (RAT) and a second RAT when the UE experiences a service outage with respect to the first (or serving) RAT and the second (or target) RAT. The UE may avoid entering the limited service state during a period of time when the UE enters a poor coverage area where communication on the first RAT (e.g., WLAN or WWAN) and the second RAT (e.g., WWAN or WLAN) is unavailable.

In one aspect of the disclosure, the UE remains on the first RAT (e.g., WiFi/LTE/GSM/TD-SCDMA) during a communication service outage, rather than unsuccessfully attempting to switch or handover to the second RAT (e.g., WiFi/LTE/GSM/TD-SCDMA) or a third RAT (e.g., WiFi/LTE/GSM/TD-SCDMA). In one aspect of the disclosure, the UE remains on the first RAT by preventing switching from the first RAT to the second RAT based on a location of the UE. For example, the UE remains on the first RAT when the UE enters the coverage area that is subject to a communication service outage with respect to the first, second and third RAT(s). In one aspect of the disclosure, the UE remains on a first RAT (e.g., WiFi) and does not attempt to change communication to the second RAT (e.g., LTE) when the UE is aware that the communication service outage associated with the first RAT is tentative or temporary. An indication that the communication service outage associated with the first RAT is temporary may be based on the location of a UE (e.g., within an elevator).

In one aspect of the disclosure, the UE determines that the communication service outage associated with the first RAT is temporary based on context information, such as personal schedule of a user. The UE uses the context information as a factor to save power and avoid switching from the first RAT (i.e., current RAT) to the second RAT when the context information indicates that the UE will connect to the second RAT for a very short time such that communication during the short period is not useful or of limited use. For example, the schedule may indicate that the UE is about to enter an elevator. Thus, if the UE just lost WiFi communications but is about to enter the elevator, the UE will not attempt to establish LTE connectivity.

In another aspect of the disclosure, the UE determines that the communication service outage associated with the first RAT (i.e., current or serving RAT) is temporary based on an indication of a connection duration of the UE to a potential new RAT (e.g., LTE/TD-SCDMA/GSM). The connection duration may be indicated before the UE switches from the current RAT (e.g., WiFi) to the new RAT.

In one aspect of the disclosure, the UE determines that the communication service outage associated with the first RAT is temporary based on the location of the UE. The location may be determined from stored identification information corresponding to a previous communication prior to a previous communication service outage in the same location. For example, if the UE was engaged in communication two days ago before entering an elevator where the UE experienced a communication service outage, identification information associated with that communication may be stored (such as an access point ID). The identification information may be recalled to determine a current location of the UE.

In yet another aspect of the disclosure, the location of the UE is determined based on a detected base station, the context information of the UE and other location detection implementations. For example, the location may be determined based on a basic service set identification (BSSID) of an access point (AP) of the first RAT from which the UE loses communication prior to entering the undesirable location (e.g., elevator). The location may also be determined based on positioning system information, such as a global positioning system (GPS) data. As noted, the context information includes personal schedule information of a user. For example, schedule information may indicate a location and time of a user's appointment.

In one aspect of the disclosure, the UE attempts to access the second RAT when the UE experiences a communication service outage with respect to the first RAT. In this aspect, the UE is prevented from attempting to access the third RAT when the attempt to access the second RAT fails. For example, the attempt is prevented when the UE experiences a communication service outage with respect to the second RAT and/or the third RAT. The UE may remain on the second RAT or continue to attempt to access the second RAT during the service outage. The UE may also attempt to return to the first RAT during the service outage associated with the second RAT, based on the location of the UE.

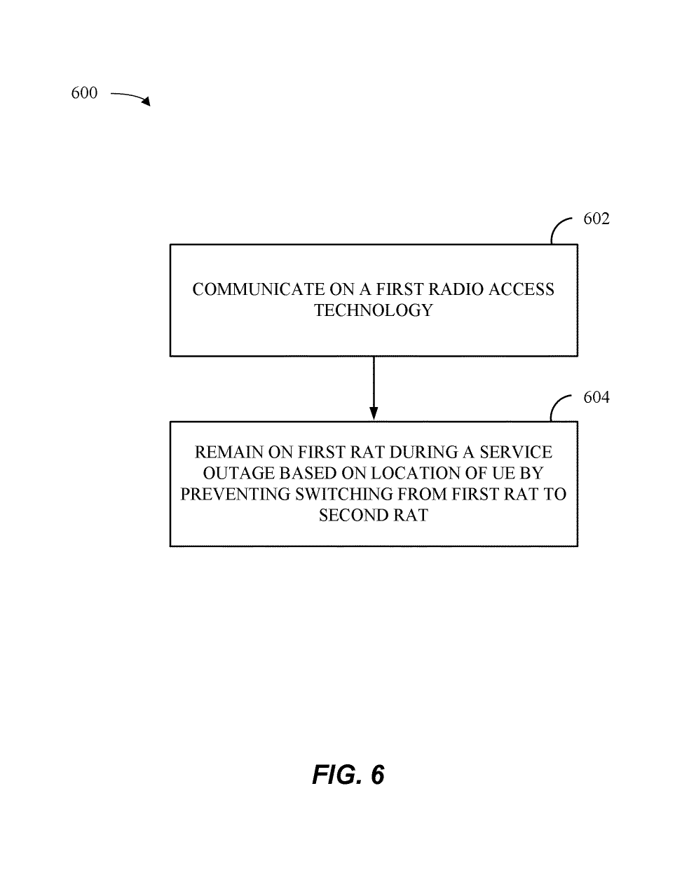

FIG. 6 shows a wireless communication method 600 according to one aspect of the disclosure. A user equipment (UE) avoids entering a limited service state during a period of time when the UE enters an undesirable coverage area. The UE communicates on a first radio access technology (RAT), as shown in block 602. The UE remains on the first RAT during a service outage, based on a location of the UE by preventing switching from the first RAT to a second RAT, as shown in block 604.

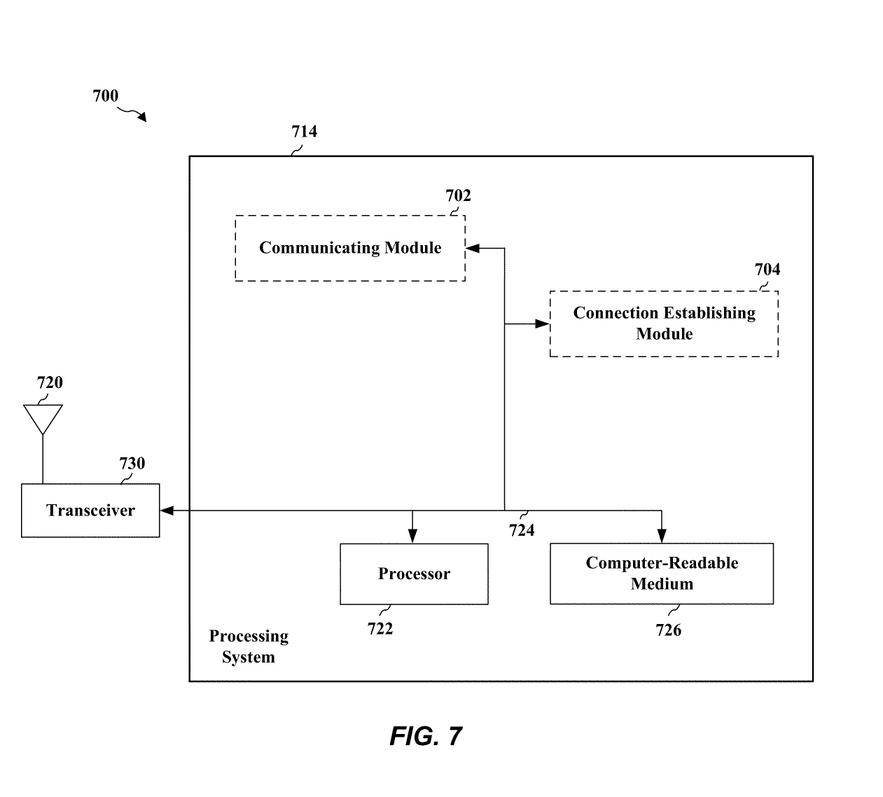

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702, 704 and the non-transitory computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a non-transitory computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a communicating module 702 for communicating on the first radio access technology. The processing system 714 includes a connection establishing module 704 for remaining on a first RAT during a service outage, based on a location of the UE by preventing switching from the first RAT to a second RAT. The modules may be software modules running in the processor 722, resident/stored in the computer-readable medium 726, one or more hardware modules coupled to the processor 722, or some combination thereof. The processing system 714 may be a component of the UE 350 and may include the memory 392, and/or the controller/processor 390.

In one configuration, an apparatus such as a UE is configured for wireless communication including means for communicating. In one aspect, the communicating means may be the antennas 352/720, the receiver 354, the transmitter 356, the transceiver 730, the channel processor 394, the receive frame processor 360, the receive processor 370, transmit frame processor 382, the transmit processor 380, the controller/processor 390, the memory 392, the multi-mode power saving module 391, the communicating module 702, and/or the processing system 714 configured to perform the aforementioned means. The UE is also configured to include means for remaining on the first RAT. In one aspect, the remaining means may be the controller/processor 390, the memory 392, the multi-mode power saving module 391, the connection establishing module 704, and/or the processing system 714 configured to perform the aforementioned means. In one configuration, the means functions correspond to the aforementioned structures. In another aspect, the aforementioned means may be any module or any apparatus configured to perform the functions recited by the aforementioned means.

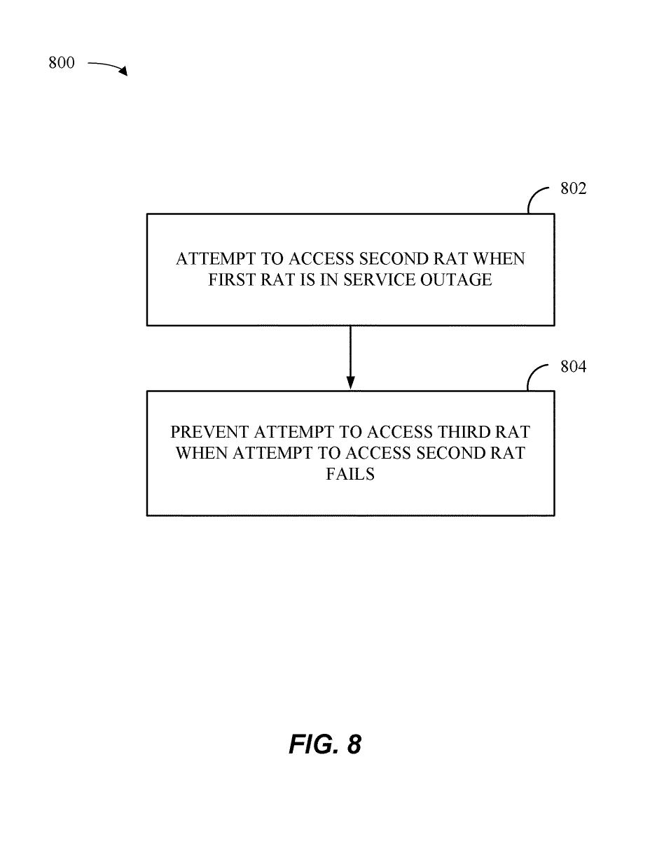

FIG. 8 shows a wireless communication method 600 according to one aspect of the disclosure. A user equipment (UE) avoids entering a limited service state during a period of time when the UE enters a weak coverage area. The UE attempts to access a second radio access technology (RAT) when a first RAT is in a service outage, as shown in block 802. The UE prevents attempts to access a third RAT when the attempt to access the second RAT fails, as shown in block 804.

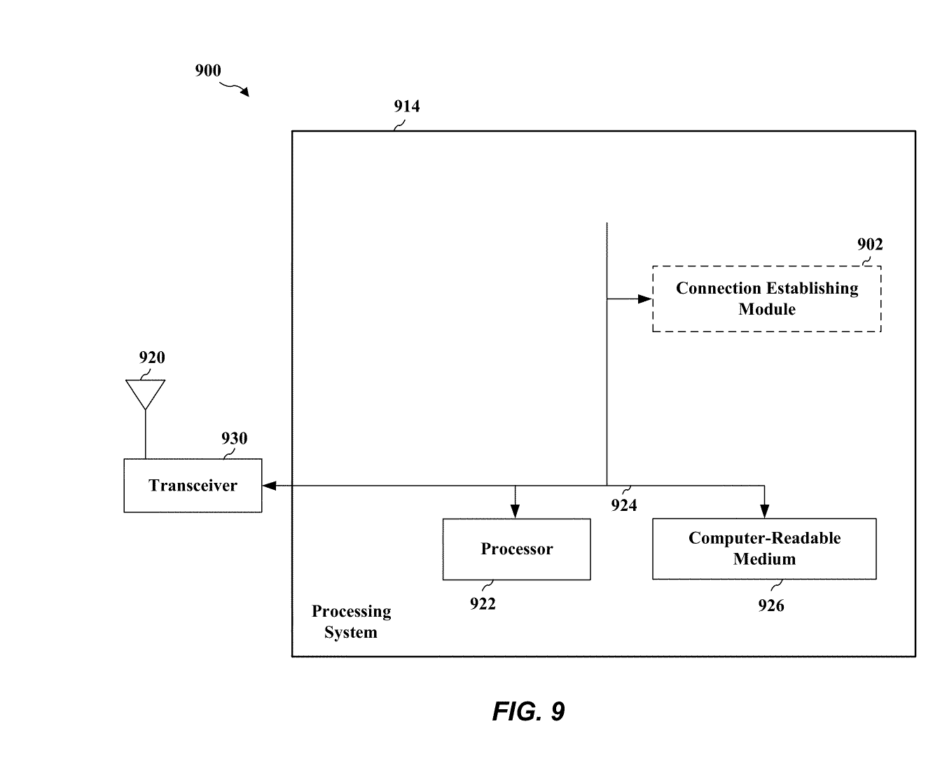

FIG. 9 is a diagram illustrating an example of a hardware implementation for an apparatus 900 employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware modules, represented by the processor 922 the module 902 and the non-transitory computer-readable medium 926. The bus 924 may also link various other circuits such as timing sources, peripherals, voltage regulators, and power management circuits, which are well known in the art, and therefore, will not be described any further.

The apparatus includes a processing system 914 coupled to a transceiver 930. The transceiver 930 is coupled to one or more antennas 920. The transceiver 930 enables communicating with various other apparatus over a transmission medium. The processing system 914 includes a processor 922 coupled to a non-transitory computer-readable medium 926. The processor 922 is responsible for general processing, including the execution of software stored on the computer-readable medium 926. The software, when executed by the processor 922, causes the processing system 914 to perform the various functions described for any particular apparatus. The computer-readable medium 926 may also be used for storing data that is manipulated by the processor 922 when executing software.

The processing system 914 includes a connection establishing module 902 for attempting to access a second radio access technology (RAT) when a first RAT is in a service outage. The connection establishing module 902 also prevents attempts to access a third RAT when the attempt to access the second RAT fails. The modules may be software modules running in the processor 922, resident/stored in the computer-readable medium 926, one or more hardware modules coupled to the processor 922, or some combination thereof. The processing system 914 may be a component of the UE 350 and may include the memory 392, and/or the controller/processor 390.

In one configuration, an apparatus such as a UE is configured for wireless communication including means for attempting to access the second RAT. In one aspect, the attempting means may be the antennas 352/920, the receiver 354, the transmitter 356, the transceiver 930, the channel processor 394, the receive frame processor 360, the receive processor 370, transmit frame processor 382, the transmit processor 380, the controller/processor 390, the memory 392, the multi-mode power saving module 391, the connection establishing module 902, and/or the processing system 914 configured to perform the aforementioned means. The UE is also configured to include means for preventing attempts to access a third RAT. In one aspect, the preventing means may be the antennas 352/920, the receiver 354, the transmitter 356, the transceiver 930, the channel processor 394, the receive frame processor 360, the receive processor 370, transmit frame processor 382, the transmit processor 380, the controller/processor 390, the memory 392, the multi-mode power saving module 391, the connection establishing module 902, and/or the processing system 914 configured to perform the aforementioned means. In one configuration, the means functions correspond to the aforementioned structures. In another aspect, the aforementioned means may be any module or any apparatus configured to perform the functions recited by the aforementioned means.

Several aspects of a telecommunications system have been presented with reference to WiFi, LTE, TD-SCDMA and GSM systems. As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
remaining on a first radio access technology (RAT) during a service outage, based at least in part on a location of a user equipment (UE) by preventing switching from the first RAT to a second RAT.

2. The method of claim 1, further comprising determining the location based at least in part on detected base station signals.

3. The method of claim 1, further comprising determining the location based at least in part on context information of the UE.

4. The method of claim 3, in which the context information comprises a personal schedule.

5. The method of claim 1, in which the first RAT comprises a wireless local area network (WLAN).

6. The method of claim 1, in which the second RAT comprises a wireless wide area network (WWAN).

7. A method of wireless communication, comprising:
attempting to access a second radio access technology (RAT) when a first RAT is in a service outage; and
preventing the attempting to access a third RAT when the attempting to access the second RAT fails.

8. The method of claim 7 further comprising remaining on the second RAT, continuing to attempt to access the second RAT during the service outage or attempting to return to the first RAT during the service outage, based at least in part on a location of a user equipment (UE).

9. The method of claim 7, in which the first RAT comprises a wireless local area network (WLAN).

10. The method of claim 7, in which the second RAT comprises a wireless wide area network (WWAN).

11. An apparatus for wireless communication, comprising:
a memory; and
at least one processor coupled to the memory and configured:
to remain on a first radio access technology (RAT) during a service outage, based at least in part on a location of a user equipment (UE) by preventing switching from the first RAT to a second RAT.

12. The apparatus of claim 11, in which the at least one processor is further configured to determine the location based at least in part on detected base station signals.

13. The apparatus of claim 11, in which the at least one processor is further configured to determine the location based at least in part on context information of the UE.

14. The apparatus of claim 13, in which the context information comprises a personal schedule.

15. The apparatus of claim 11, in which the first RAT comprises a wireless local area network (WLAN).

16. The apparatus of claim 11, in which the second RAT comprises a wireless wide area network (WWAN).

17. An apparatus for wireless communication, comprising:
a memory; and
at least one processor coupled to the memory and configured:
to attempt to access a second radio access technology (RAT) when a first RAT is in a service outage; and
to prevent the attempting to access a third RAT when the attempting to access the second RAT fails.

18. The apparatus of claim 17, in which the at least one processor is further configured to remain on the second RAT, to continue to attempt to access the second RAT during the service outage or to attempt to return to the first RAT during the service outage, based at least in part on a location of a user equipment (UE).

19. The apparatus of claim 17, in which the first RAT comprises a wireless local area network (WLAN).

20. The apparatus of claim 17, in which the second RAT comprises a wireless wide area network (WWAN).
